(19) United States
(12) Patent Application Publication
(10) Pub. No.: US 2008/0077183 A1
(43) Pub. Date: Mar. 27, 2008

(54) Well-being of an infant by monitoring and responding to non-nutritive sucking

(75) Inventor: Jason C. Cohen, Appleton, WI (US)

Correspondence Address: KIMBERLY-CLARK WORLDWIDE, INC.;Catherine E. Wolf, 401 NORTH LAKE STREET, NEENAH, WI, 54956, US

(73) Assignee: Kimberly-Clark Worldwide, Inc.

(21) Appl. No.: 11/507,137

(22) Filed: Aug. 18, 2006

(51) Int. Cl. A61J 17/00

(52) U.S. Cl. 606/234

(57) ABSTRACT

Caregivers such as parent and day care providers desire to keep the infants under their care as happy as possible. One way that caregivers try to accomplish this is by modifying the environment of the infants as they analyze signals of their happiness, alertness and/or agitation. This analysis requires the caregiver to have enough time and opportunity to observe the infant's signals, and remember the behavior to detect patterns. This becomes additionally difficult when multiple caregivers provide care such as with day cares. Further, at times the caregiver may not wish to be in the same room as the infant, such as during naps, or during the night.

### BACKGROUND

The comfort, well-being, or stress level of an infant in relation to their environment may be difficult to determine and/or quantify. Generally, an infant provides signals as to his or her comfort, well-being, or stress level in the form of facial expressions, other physical motions, and sounds. Some signals, such as smiling and cooing, may indicate that the infant is satisfied or happy with current environmental conditions and/or bodily conditions. Other signals, such as crying, generally indicate that the infant is not satisfied with current environmental conditions and/or bodily conditions. Such signals, whether indicative of a positive state of well-being (smiling and cooing) or a negative state of well-being (crying) may not be quantifiable and/or readily correlatable to the infant's perception of their environment and may not be present in very young infants.

Caregivers such as parents and day care providers desire to keep the infants under their care as happy as possible. One way that caregivers try to accomplish this is by modifying the environment of the infants as they analyze signals of their happiness, alertness and/or agitation. This analysis requires the caregiver to have enough time and opportunity to observe the infant's signals, and remember the behavior to detect patterns. This becomes additionally difficult when multiple caregivers provide care such as with day cares. Further, at times the caregiver may not wish to be in the same room as the infant, such as during naps, or during the night.

What is needed is a method by which an infant's environment is modified as signals of the infant's happiness, alertness and/or agitation change.

### SUMMARY

In general, the present disclosure is directed to a method and an apparatus to modify the environment of an infant. For example, in one embodiment, the method includes monitoring non-nutritive sucking of an infant. The method also includes determining a baseline of the non-nutritive sucking and detecting a deviation from the baseline of the non-nutritive sucking. Further, the method includes adjusting a first component of the environment upon detecting the deviation from the baseline of the non-nutritive sucking.

Another version of the present invention includes a method including monitoring non-nutritive sucking of an infant. The method also includes determining a baseline of the non-nutritive sucking and detecting deviation from the baseline of the non-nutritive sucking. The method also includes adjusting a first component of the environment upon detecting the deviation from the baseline of the non-nutritive sucking if the deviation is of a first type. Further, the method includes adjusting a second component of the environment upon detecting the deviation from the baseline of the non-nutritive sucking if the deviation is of a second type of deviation. The first component of the environment is different from the second component of the environment, and the first type of deviation is different from the second type of deviation.

Finally, another version of the present invention includes a pacifier adapted to detect non-nutritive sucking events. The pacifier includes a nipple, a base attached to the nipple, and a sensor attached to the base. The sensor is adapted to detect non-nutritive sucking events produced by an infant sucking on the nipple. The pacifier also includes an information device attached to the base and operatively connected to the sensor. The information device is adapted to monitor the non-nutritive sucking of the infant and determine a baseline of the non-nutritive sucking. The information device is also adapted to detect a deviation from the baseline of the non-nutritive sucking, and adjust a first component of the environment upon detecting the deviation from the baseline of the non-nutritive sucking.

### DRAWINGS

FIG. 1 representatively illustrates a pacifier adapted to detect non-nutritive sucking events produced by a baby sucking on the pacifier.

FIGS. 2A, 2B, 2C, 2D, 2E, and 2F representatively depict modification of a pacifier into one version of a device adapted to detect non-nutritive sucking events and/or rhythmic sucking patterns.

FIG. 3 representatively depicts modification of a pacifier into one version of a device adapted to detect non-nutritive sucking events and/or rhythmic sucking patterns.

FIGS. 4A and 4B representatively depict modification of a pacifier into one version of a device adapted to detect non-nutritive sucking events and/or rhythmic sucking patterns.

FIGS. 5A and 5B representatively depict another version of a device adapted to detect non-nutritive sucking events and/or rhythmic sucking patterns.

Corresponding reference characters indicate corresponding parts throughout the drawings.

### Definitions

Within the context of this specification, each term or phrase below includes the following meaning or meanings:

“Attach” and its derivatives refer to the joining, adhering, connecting, bonding, sewing together, or the like, of two elements. Two elements will be considered to be attached together when they are integral with one another or attached directly to one another or indirectly to one another, such as when each is directly attached to intermediate elements. “Attach” and its derivatives include permanent, releasable, or refastenable attachment. In addition, the attachment can be completed either during the manufacturing process or by the end user.

“Bond” and its derivatives refer to the joining, adhering, connecting, attaching, sewing together, or the like, of two elements. Two elements will be considered to be bonded together when they are bonded directly to one another or indirectly to one another, such as when each is directly bonded to intermediate elements. “Bond” and its derivatives include permanent, releasable, or refastenable bonding.

“Connect” and its derivatives refer to the joining, adhering, bonding, attaching, sewing together, or the like, of two elements. Two elements will be considered to be connected together when they are connected directly to one another or indirectly to one another, such as when each is directly connected to intermediate elements. “Connect” and its derivatives include permanent, releasable, or refastenable connection. In addition, the connecting can be completed either during the manufacturing process or by the end user.

“Disposable” refers to articles which are designed to be discarded after a limited use rather than being laundered or otherwise restored for reuse.

The terms “disposed on,” “disposed along,” “disposed with,” or “disposed toward” and variations thereof are intended to mean that one element can be integral with another element, or that one element can be a separate structure bonded to or placed with or placed near another element.

“Fluid” refers to urine, a bowel movement (“BM”), a urine simulant, a BM simulant, or other such liquid or material.

“Member” when used in the singular can have the dual meaning of a single element or a plurality of elements.

“Operatively connected” refers to the communication pathway by which one element, such as a sensor, communicates with another element, such as an information device. Communication may occur by way of an electrical connection through a conductive wire. Communication may otherwise occur via a transmitted signal such as an infrared frequency, a radio frequency, or some other transmitted frequency signal. Alternatively, communication may occur by way of a mechanical connection, such as a hydraulic or pneumatic connection.

These terms may be defined with additional language in the remaining portions of the specification.

### Description

### Representative Devices and Sensors for Detecting Non-Nutritive Sucking Events

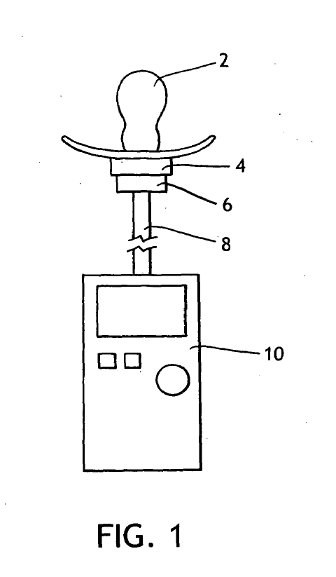

A representative device, adapted to detect non-nutritive sucking events produced by an infant, is depicted in FIG. 1, along with an information device. A nipple 2 is attached to a base 4. A sensor 6 is attached to the base so that an infant's sucking on the nipple is detected. For example, as outlined in the Examples section below, we modified commercially available pacifiers (e.g., a NUK®-brand pacifier made by NUK, MAPA GmbH, Industriestrasse 21-25, D-27404, Zeven, Germany; a MAM®-brand pacifier made by MAM Babyartikel GEsmbh, Lorenz-Mandl-Gasse 50, 1160 Wien, Austria; and a Disney®-brand/The-First-Years®-brand pacifier made by The First Years, One Kiddie Drive, Avon, Mass.) can be modified by attaching a pressure transducer to the base of each pacifier using an epoxy glue. Pressure transducers available from Omega Engineering, having offices at One Omega Drive, Box 4047, Stamford, Conn. can be used. As discussed below in the Examples section, three different pressure transducers, each capable of measuring different ranges of pressure, can be used: (1) 0 to 1 pound per square inch (PSI) (model no. PX26-001GV, which corresponds to 0 to about 16.7 millivolts DC full scale); (2) 0 to 5 PSI (model no. PX26-005GV, which corresponds to 0 to about 50 millivolts DC full scale); and (3) 0 to 15 PSI (model no. PX26-015GV, which corresponds to 0 to about 100 millivolts DC full scale). An epoxy adhesive available from Cole-Parmer Instrument Company, having offices at 625 East Bunker Court, Vernon Hills, Ill., was used to attach the pressure transducer to the base of the pacifier. By operatively connecting the modified pacifier to a digital multimeter available from Fluke Corporation, having offices at 6920 Seaway Boulevard, Everett, Wash. (or, as described below, a computer having an analog-to-digital device), changes in pressure inside the nipple of the modified pacifier can be monitored. In FIG. 1, the operative connection is exemplified by a wire 8 connected to an information device 10, in this case the aforementioned multimeter. As mentioned elsewhere, the sensor 6 may be operatively connected to an information device in various ways, including use of a conductive wire, a selected portion of the electromagnetic spectrum (e.g., a wireless connection using radio waves), or a mechanical connection (e.g., a pneumatic connection).

An infant's sucking on the nipple causes the flexible nipple to stretch or extend, and then return to its original shape. This periodic extending or stretching of the nipple subjects the inside of the nipple to periodic compression, thereby changing the pressure inside the nipple. By operatively connecting a pressure transducer to the volume inside the nipple, the pressure inside the nipple, or a value corresponding to pressure inside the nipple, can be monitored. In some instances, a multimeter can be used to display a reading, in millivolts, that corresponded to the pressure inside the nipple. In other cases, a computer with an analog-to-digital device, and software adapted to configure the computer for collecting and processing data can be used, to process and display readings corresponding to the pressure inside the nipple. Additional detail regarding the construction of this modified pacifier, and its use, is given in the Examples section below.

Other sensors may be used to detect non-nutritive sucking events produced by an infant. For example, a strain gauge could be attached to a pacifier to detect any deflection or deformation of one or more elements of the pacifier (e.g., the nipple, the base to which the nipple is attached, etc.).

Alternatively, a sensor for detecting electrical signals associated with contraction of a muscle or muscle group could be used to detect non-nutritive sucking events produced by an infant. For example, a sensor comprising electrodes and capable of being adhered to skin could be used to detect such sucking events, whether effected by an infant sucking on a pacifier, the nipple on a bottle, the infant's own thumb, finger, or fingers, and the like.

If the non-nutritive sucking events produce sounds, then a device for monitoring audible events could be used to detect the sounds corresponding to non-nutritive sucking events.

While the preceding paragraphs provide examples of devices, sensors, and methods that may be used to detect non-nutritive sucking events produced by an infant, as well as different ways by which infants effect non-nutritive sucking events (e.g., by sucking on a pacifier, a nipple on a bottle, the infant's own thumb, etc.), other devices, sensors, methods, and ways of generating non-nutritive sucking events may be used, so long as the selected approach is capable of detecting the non-nutritive sucking events.

### Representative Information Devices

A multimeter, discussed in the preceding paragraphs and in the Examples section below, is one version of an information device; i.e., a device adapted to accomplish one or more of receiving, storing, processing, displaying, or transmitting information, in this case information corresponding to non-nutritive sucking events produced by an infant, and detected by a sensor. A multimeter can be used in some cases to display a reading, in millivolts, that corresponds to the pressure inside a modified pacifier. An infant's sucking on that pacifier will produce a measurable rhythmic sucking pattern (“RSP”)—i.e., a series of millivolt readings that can be plotted and evaluated.

A variety of information devices may be used in conjunction with the present invention. For example, a computer may be used to monitor one or more values corresponding to the non-nutritive sucking events produced by an infant. Generally, a computer is capable of receiving, storing, processing, displaying, and transmitting information. Through the use of appropriate software, the computer can be configured to receive, store, process, display, and/or transmit information corresponding to non-nutritive sucking events produced by an infant. A computer can be used to accumulate individual millivolt readings corresponding to individual non-nutritive sucking events. These readings can be processed further to calculate an average value for an infant in an environment in which external stimuli remained relatively unchanged; and an average value in an environment in which external stimuli were changed in a controlled fashion (for example, by activating a pump which transports a liquid to the diaper worn by the infant). An example of this is discussed in more detail below, but it is highlighted now to provide an example of how one version of an information device is used to quantify and process non-nutritive sucking events and rhythmic sucking patterns, which can provide indicia of an infant's perception of the performance of an absorbent article worn by the infant.

Many different information devices may be used with the present invention. In addition to a desktop computer or a device for recording and/or displaying readings corresponding to non-nutritive sucking events (e.g., a multimeter displaying millivolt readings), a personal-digital assistant, hand-held computer, a portable computer, or other compact device can be used to receive, store, process, display, and/or transmit information corresponding to non-nutritive sucking events produced by an infant. Alternatively, a chart recorder or other such device for recording the detected non-nutritive sucking events may be used. As noted above, the information device may comprise a storage device, including, for example, RAM (i.e., Random Access Memory), ROM (i.e., Read-Only Memory), EPROM (i.e., Erasable Programmable Read-Only Memory), PROM (i.e., Programmable Read-Only Memory), RFID (i.e., Radio Frequency IDentification), or the like. Furthermore, information devices comprising storage devices such as those identified in the preceding list may be compact enough to be attached to the sensor used to detect non-nutritive sucking events produced by an infant. For example, an RFID device could be incorporated into a pacifier such that the device recorded the non-nutritive sucking events produced by an infant sucking on the nipple of the pacifier. When desired, an external device could be used to read the stored information on the RFID element. Alternatively, the information on the RFID element could be viewed on a display, either on the pacifier itself, or on a computer or other information device remote from the pacifier. In some versions of the invention, the information device will comprise only a storage device.

A display may be connected to the sensor itself (e.g. a pacifier having both a pressure transducer to sense the non-nutritive sucking events and an information device comprising a display) to provide an indication or information corresponding to non-nutritive sucking events detected by the sensor and/or stored on the information device. The display could be graphical in nature, with displayed images corresponding to a psychological state or state of well-being indicated by non-nutritive sucking events and/or rhythmic sucking patterns. So, for example, if certain rhythmic sucking patterns were generally determined to correspond to a more stressful condition for an infant, then the graphical display on the pacifier might, for example, be an image of a face with a frown. Alternatively, if certain rhythmic sucking patterns were generally determined to correspond to a less stressful condition for the infant, then the graphical display on the pacifier might, for example, be an image of a face with a smile. Furthermore, color might be used either alone, or in conjunction with graphical images, to convey information regarding the well-being, stress level, psychological state, or perceptions of the infant. Any hardware and software capable of presenting a display of information, graphical or otherwise, might be used, including, for example, liquid-crystal displays, light-emitting diodes, and the like. In some versions of the invention, the graphical display is associated with an information device remote from the sensor used to detect non-nutritive sucking events and/or rhythmic sucking patterns (as is discussed in more detail in the following paragraph).

It should be noted that the information device need only be operatively connected to the sensor used to detect non-nutritive sucking events. Accordingly, the information device might be attached to the sensor itself, or the information device might be at a location remote from the sensor, with information conveyed by an appropriate wavelength in the electromagnetic spectrum (e.g., radio waves); a conductive wire; or some mechanical connection (e.g., a pneumatic or hydraulic connection). In some cases, the information device may comprise one or more components attached to the sensor used to detect non-nutritive sucking events, and one or more components at a location remote from the sensor.

The method of the present invention monitors non-nutritive sucking of an infant on a regular basis, for example by using a modified pacifier as described in FIG. 1. Through monitoring of the non-nutritive sucking a baseline is determine which represents a steady state in the emotional and physiological situation of the infant.

The determination of this baseline may be accomplished utilizing an algorithm which identifies stable patterns in the non-nutritive sucking. Alternatively, a caregiver may provide an input which indicates that a baseline condition exists. The present invention then monitors the non-nutritive sucking to detect a deviation from the baseline. This deviation may come in many different forms. For example, if the baseline can be characterized by a representative frequency and representative amplitude, an increase or a decrease in the frequency may constitute a deviation. Alternatively, an increase or a decrease in the amplitude may constitute a deviation.

If the baseline is characterized by a representative standard deviation of the frequency and/or amplitude, an increase or a decrease in the standard deviation of the frequency may constitute a deviation. Alternatively, an increase or a decrease in the standard deviation of the amplitude may constitute a deviation. Another deviation may be a pause in the non-nutritive sucking of a given duration.

Variation in the baseline may require that minor changes in the non-nutritive sucking be overlooked. For example, the method of the present invention may allow for a 5% change in the amplitude of the non-nutritive sucking before a deviation is detected. Alternatively, a 10%, 25%, or 50% change in a characteristic of the baseline may be allowed before a deviation is detected.

The method of the present invention allows for changes in the infant's non-nutritive sucking as the child changes. For example, as the child grows and gets stronger, it would be anticipated the amplitude or strength of the baseline non-nutritive sucking would increase. The present invention allows for monitoring of the non-nutritive sucking over time and adjustment to the baseline as the child changes.

Additionally, the variation from baseline which triggers a deviation may also change over time. For example, parents of a one month old may wish to respond very quickly to any change in the physical or emotional condition of the infant. These same parents, of the same infant, two months later, may determine that allowing either larger changes to the physical or emotional condition of the infant may be beneficial or required. The present invention may allow for the caregiver to either require a larger variation from baseline to trigger a deviation, or require the variation from baseline to exist for a longer period of time to trigger a deviation. Other condition, such as a cold or flu, may prompt the caregiver of the infant to either increase or decrease the variation from baseline to trigger a deviation.

Upon detecting a deviation from the baseline of the non-nutritive sucking, the present invention adjusts a component of the environment of the infant. This adjustment of the component of the environment of the infant may affect the infant in many ways as determined by the caregiver. For example, the deviation of the non-nutritive sucking may indicate that the infant is becoming less awake. If the intent is to allow the child to sleep, the environment may be adjusted to become more conducive to sleep, such as decreasing a light level, decreasing sound level, decreasing a level of motion of an object visible to the infant (such as a mobile), or decreasing a level of motion of the infant (such as rocking). If the intent is to keep the child awake, the environment may be adjusted to become less conducive to sleep, such as increasing a light level, increasing a sound level, increasing a level of motion of an object visible to the infant, or increasing a level of motion of the infant. The grouping of adjustments are given only as an example, some caregivers may determine that their infant may prefer adjustments to the environment which are opposite to the ones indicated above.

In some situations, the non-nutritive sucking may be indicating the physical comfort level of the infant, for example being cold or being warm. In these situations the environment may be adjusted by changing the level of motion of the air surrounding the infant, for instance adjusting a fan, or by changing the temperature of the air the surface the infant is in contact with.

The non-nutritive sucking may be indicative of physical pain. In this situation, the environment may be adjusted by changing an amount of a substance introduced into the infant, for example either an oral or intravenous drug. Alternatively, the adjustment to the environment may be a fragrance level.

Initially, deviations from baseline may be utilized to notify the caregiver. The caregiver may then be prompted to provide information regarding a status of the infant. For example, the deviation may be a sharp increase in amplitude following a long steady state in the baseline. The caregiver may provide the information that the child became agitated after becoming scared, or that the child became wakeful after resting. The caregiver may then provide information on which component or components of the environment to change and in which direction and by how much.

The present invention may be utilized to modify different conditions depending on different deviations from baseline. For example, if the amplitude of the non-nutritive sucking increases, the lights may be turned on, and if the frequency of the non-nutritive sucking increases, a fan may be turned on.

### EXAMPLES

### Example 1

### Construction of One Version of a Device Adapted to Detect Non-Nutritive Sucking Events and/or Rhythmic Sucking Patterns

A Disney®-brand pacifier, manufactured by The First Years, One Kiddie Drive, Avon, Mass., was obtained.

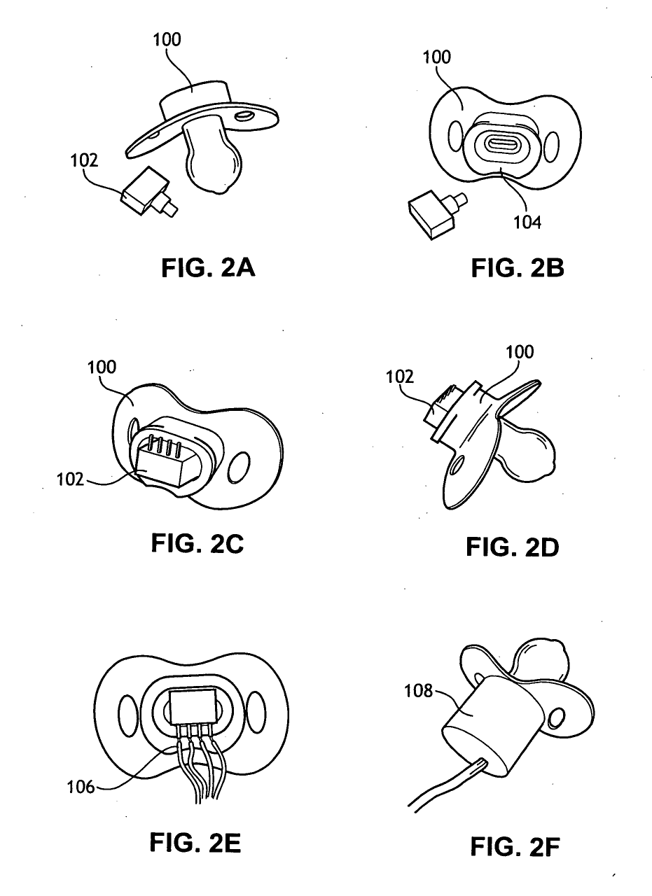

The pacifier was modified as depicted in FIGS. 2A through 2F. FIG. 2A depicts the pacifier 100 along with a pressure transducer 102 obtained from Omega Engineering, having offices at One Omega Drive, Box 4047, Stamford, Conn. This particular pressure transducer (model no. PX26-001GV) was adapted to detect pressure readings from zero to one pound per square inch. FIG. 2B depicts the pacifier 100 modified such that the back of the base has been removed to reveal the end of the nipple 104 which is attached to the base.

FIGS. 2C and 2D show the pressure transducer 102 inserted into the opening created by removing the back of the base. In this version of a device adapted to detect non-nutritive sucking events and/or rhythmic sucking patterns, epoxy is used to attach the pressure transducer 102 to the base of the pacifier. A sufficient amount of epoxy was used so that epoxy filled the space between the portion of the transducer that was inserted into the base and the inner wall of the base. A substantially air-tight seal was formed between the transducer and the base of the pacifier.

FIG. 2E shows a four-conductor ribbon cable 106 soldered to the pressure transducer. FIG. 2F depicts a protective sleeve 108 positioned around the pressure transducer.

Note also that a drill with a #60 drill bit was used to drill a hole through the solidified epoxy (at a location near the transducer) such that a port to the open end of the nipple was created. The port allowed the nipple to vent air from its interior when squeezed or compressed; and to draw air into its interior when allowed to return to its original shape. The port allowed the nipple to collapse and return to its original shape during use. The port was added because the original, unmodified pacifier had a vent/port, but the original vent was eliminated when we removed the back of the pacifier and attached the transducer with epoxy.

### Example 2

### Construction of Another Version of a Device Adapted to Detect Non-Nutritive Sucking Events and/or Rhythmic Sucking Patterns

A MAM®-brand pacifier made by MAM Babyartikel GEsmbh, Lorenz-Mandl-Gasse 50, 1160 Wien, Austria, was obtained.

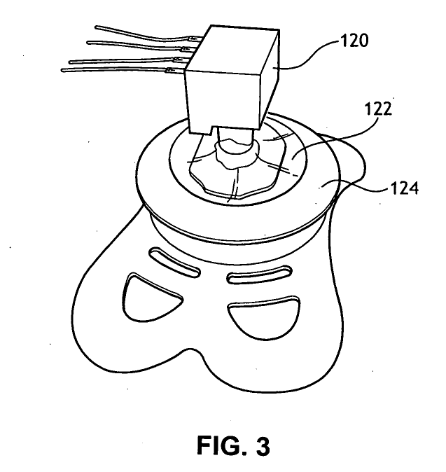

The pacifier was modified as follows. As depicted in FIG. 3, a pressure transducer 120, obtained from Omega Engineering, having offices at One Omega Drive, Box 4047, Stamford, Conn., was attached to the open end 122 of a base 124 of a pacifier. Epoxy was used to attach the pressure transducer to the pacifier. A sufficient amount of epoxy was used so that epoxy filled the space between the portion of the transducer that was inserted into the base and the inner wall of the base. A substantially air-tight seal was formed between the transducer and the base of the pacifier. This particular pressure transducer was adapted to detect pressure readings of zero to 5 pounds per square inch. As with Example 1, a #60 drill bit was used to drill a hole into the side of the epoxy such that a port to the open end of the nipple was created. The port allowed the nipple to vent air from its interior when squeezed or compressed; and to draw air into its interior when allowed to return to its original shape.

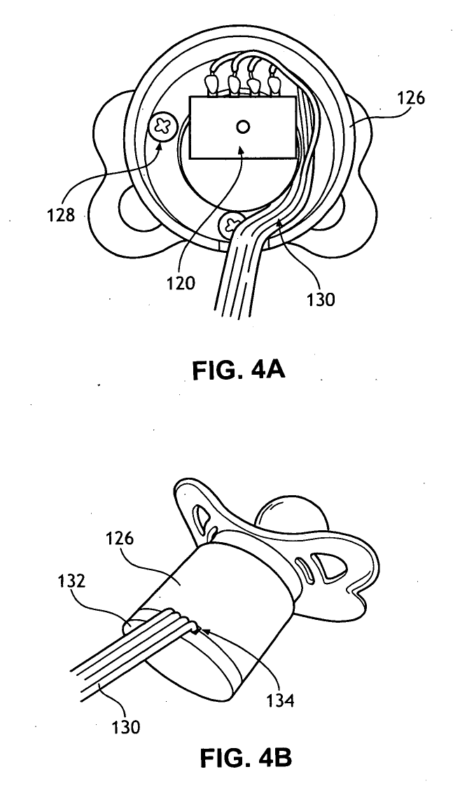

FIG. 4A depicts a protective cup 126 attached to the base of the pacifier using #2-56 screws 128. A four-conductor ribbon cable 130 was soldered to each of the four connectors of the pressure transducer. FIG. 4B shows the modified pacifier with an end cap 132 attached to the protective cup 126. A notch 134 allows for egress of the ribbon cable 130 from the interior of the protective cup 126.

Note also that a drill with a #60 drill bit was used to drill a hole through the solidified epoxy (at a location near the transducer) such that a port to the open end of the nipple was created. The port allowed the nipple to vent air from its interior when squeezed or compressed; and to draw air into its interior when allowed to return to its original shape. The port allowed the nipple to collapse and return to its original shape during use. The port was added because the original, unmodified pacifier had a vent/port, but the original vent was eliminated when we removed the back of the pacifier and attached the transducer with epoxy.

### Example 3

### Construction of Another Version of a Device Adapted to Detect Non-Nutritive Sucking Events and/or Rhythmic Sucking Patterns

A Nuk®-brand pacifier, manufactured by NUK, MAPA GmbH, Industriestrasse 21-25, D-27404, Zeven, Germany, was obtained.

The pacifier was modified in the same way as the pacifier discussed in Example 2. In this case, however, a pressure transducer capable of detecting 0 to 15 pounds per square inch (0 to 100 millivolt DC, output) was attached to the base of the pacifier. The pressure transducer (model no. PX26-015GV; 0-15 psi) was obtained from Omega Engineering, having offices at One Omega Drive, Box 4047, Stamford, Conn.

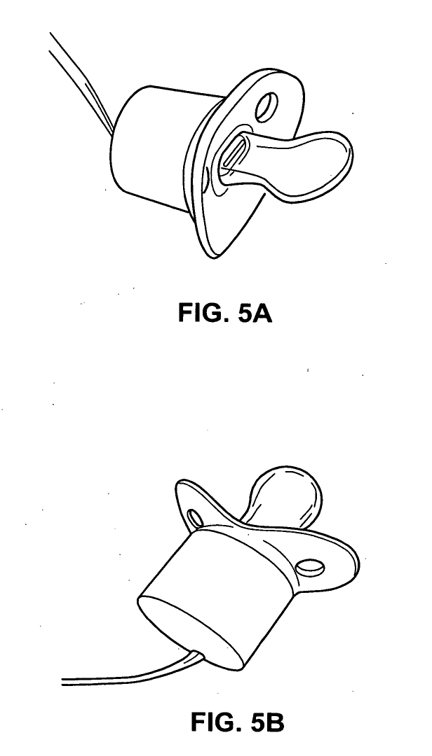

FIGS. 5A and 5B depict two different views of this version of a device adapted to detect non-nutritive sucking events and/or rhythmic sucking patterns.

### Example 4

### Test Showing Change in Rhythmic Sucking Pattern in Response to Liquid Insult to Disposable Article Worn by Infant

A nurse fitted a 3- to 6-month-old female infant with a diaper 164 to which tubing was attached for purposes of introducing a liquid insult. The end of the tubing was positioned between the inner surface of the diaper and the infant's skin at a location proximate to the infant's genitalia (i.e., where the infant would typically insult a diaper with urine). The infant was placed in a prone position. The mother of the infant was present, and seen by the infant, during the test. The device 140 (in this case, a pacifier modified to comprise a pressure transducer) was placed in the infant's mouth by the mother or nurse. As expected, the infant sucked on the pacifier, with each of these non-nutritive sucking events being detected by a sensor (in this case a pressure transducer). The analog output of the transducer was converted by the analog-to-digital interface 148 into digital format for processing and display by the computer 150 configured with the LabView (version 6.1) software.

First non-nutritive sucking events affected by the infant were monitored to obtain a baseline for future comparisons (i.e., comparisons between the pattern of non-nutritive sucking events obtained in the absence of a controlled external stimulus and the pattern of non-nutritive sucking events obtained in the presence of a controlled external stimulus). As stated above, the mother of the infant was visible to the infant at all times. After approximately one or two minutes, a baseline value of 4.34 mV for the average amplitude of the non-nutritive sucking events (i.e., the rhythmic sucking pattern, or “RSP”) was obtained. After one or two minutes the pattern of individual non-nutritive sucking events was stable and regular, and had the appearance of a repeating sawtooth pattern (with each tooth, or spike, corresponding to an increase in amplitude in mV due to the infant sucking on the pacifier). As discussed earlier, each suck flexes the nipple of the pacifier, causing a pressure change inside the nipple. The sensor selected for this exemplary system, a pressure transducer, detects these pressure changes in the form of a change in an analog output (in units of millivolts).

The Masterflex peristaltic pump 132 was then activated to prime the pump, which took approximately 5-10 seconds. “Priming” means the pump was turned on to remove any unwanted air pockets (in this case from the tubing). Liquid was not transported to the diaper worn by the infant while the pump was being primed. During this time, the average amplitude of the rhythmic sucking pattern increased to 6.75 mV. Apparently the sound of the activated pump, being sensed by the infant, translated into a response such that the amplitudes of some of the individual sucking events increased, resulting in an increase of the average amplitude for the collection of individual sucking events (i.e., the rhythmic sucking pattern). Shortly thereafter (e.g., 5-10 seconds after the pump was activated), the average amplitude of the individual non-nutritive sucking events returned to a value proximate to the baseline value of 4.34 mV.

After the pump was primed, the diaper was treated with two, 60 mL liquid insults, delivered at a volumetric flow rate of 300 mL per minute, with each of the two liquid insults separated by a 45 second pause. A first insult of 60 mL of liquid was delivered to the diaper at a volumetric flow rate of 300 mL per minute, followed by a 45 second pause. Then a second insult of 60 mL of liquid was delivered to the diaper at a volumetric flow rate of 300 mL per minute, followed by a 45 second pause. We had planned to apply a third and final insult of 60 mL of liquid (delivered to the diaper at a volumetric flow rate of 300 mL per minute), but the infant spit out the pacifier. The liquid that was delivered to the diaper was a 0.9% by weight NaCl solution, warmed to a temperature of 98.6° F.

The average amplitude of the rhythmic sucking pattern during the first insult was 4.79 mV. The average of 4.79 mV was calculated by taking the average of individual amplitudes of individual non-nutritive sucking events detected over the course of the liquid insult as well as the 45-second interval that followed. Data was taken for a total of 57 seconds (12 seconds to deliver 60 mL at a volumetric flowrate of 300 mL per minute plus 45 seconds). The average amplitude of the rhythmic sucking pattern during this second insult was 5.25 mV (again, the average amplitude corresponds to the average of individual amplitudes taken over a 57-second interval—i.e., the 12 seconds taken to deliver 60 mL at a volumetric flowrate of 300 mL per minute plus 45 seconds).

The pump was then turned off, and the infant was fitted with a new diaper. After about five minutes, the same sequence of actions described above was followed again. The average amplitude for the baseline RSP was determined to be 4.2 mV. The average amplitude of the RSP during pump priming (apparently attributable to the infant detecting a change in the audible environment) increased to 5.8 mV. The average amplitudes during the first and second insults were 4.6 and 5.19 mV, respectively.

The data collected during these tests are summarized in Table 1 below. The data demonstrate that sensing non-nutritive sucking events and/or rhythmic sucking patterns may be used to provide indicia of an infant's perception of his or her environment, including the performance of, or changes to, a disposable absorbent article worn by the infant.

TABLE 1
Changes to Rhythmic Sucking Pattern

| | | | | % Change |
|---|---|---|---|---|
| | | | | Between |
| | | | | Average |
| | | | Standard | Amplitude |
| | | | Deviation | of Initial |
| | | | of | RSP and Average |
| | Average | | Average | Amplitude of RSP |
| | Amplitude | Frequency | Amplitude | Determined During |
| | (mV) | (Hz) | (mv) | Insult |
| First | | | | |
| Experiment | | | | |
| Initial RSP | 4.34 | 1.38 | 1.57 | Not applicable |
| RSP During | 6.75 | 1.53 | 2.45 | Not applicable |
| Priming of | | | | |
| Pump | | | | |
| RSP During | 4.79 | 1.31 | 2.16 | 10 |
| First Insult | | | | |
| RSP During | 5.25 | 1.41 | 1.84 | 21 |
| Second Insult | | | | |
| Second | | | | |
| Experiment | | | | |
| Initial RSP | 4.2 | 1.51 | 1.09 | Not applicable |
| RSP During | 5.8 | 2.22 | 1.6 | Not applicable |
| Priming of | | | | |
| Pump | | | | |
| RSP During | 4.62 | 1.59 | 1.16 | 10 |
| First Insult | | | | |
| RSP During | 5.19 | 1.35 | 1.71 | 24 |
| Second Insult | | | | |

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1) A method of modifying the environment of an infant, comprising:
monitoring non-nutritive sucking of the infant;
determining a baseline of the non-nutritive sucking;
detecting a deviation from the baseline of the non-nutritive sucking; and
adjusting a first component of the environment upon detecting the deviation from the baseline of the non-nutritive sucking.

2) The method of claim 1 wherein the first component of the environment is a sound level.

3) The method of claim 1 wherein the first component of the environment is a light level.

4) The method of claim 1 wherein the first component of the environment is a level of motion of an object visible to the infant.

5) The method of claim 1 wherein the first component of the environment is a level of motion of the infant.

6) The method of claim 1 wherein the first component of the environment is a level of motion of the air surrounding the infant.

7) The method of claim 1 wherein the first component of the environment is a fragrance level.

8) The method of claim 1 wherein the first component of the environment is an amount of a substance introduced into the infant.

9) The method of claim 1 wherein the first component of the environment is a temperature level.

10) The method of claim 1 wherein the deviation includes an increase in a frequency of the baseline.

11) The method of claim 1 wherein the deviation includes a decrease in a frequency of the baseline.

12) The method of claim 1 wherein the deviation includes an increase in an amplitude of the baseline.

13) The method of claim 1 wherein the deviation includes a decrease in an amplitude of the baseline.

14) The method of claim 1 wherein the deviation includes an increase in a standard deviation of a frequency of the baseline.

15) The method of claim 1 wherein the deviation includes a decrease in a standard deviation of a frequency of the baseline.

16) The method of claim 1 wherein the deviation includes an increase in a standard deviation of an amplitude of the baseline.

17) The method of claim 1 wherein the deviation includes a decrease in a standard deviation of an amplitude of the baseline.

18) The method of claim 1 wherein the deviation includes a pause in the non-nutritive sucking.

19) The method of claim 1 further comprising notifying a caregiver of the deviation from the baseline and receiving from the caregiver information regarding a status of the infant.

20) The method of claim 19 wherein the status is an agitation level of the infant.

21) The method of claim 19 wherein the status is a wakefulness level of the infant.

22) The method of claim 1 wherein the monitoring step comprises monitoring a pressure transducer adapted to detect the non-nutritive sucking.

23) The method of claim 22 wherein the pressure transducer is attached to a pacifier.

24) The method of claim 1 wherein the determining step includes an information device adapted to accomplish one of more of receiving, storing, processing, displaying, or transmitting information corresponding to the non-nutritive sucking events.

25) A method of modifying the environment of an infant, comprising:
monitoring non-nutritive sucking of the infant;
determining a baseline of the non-nutritive sucking;
detecting deviation from the baseline of the non-nutritive sucking;
adjusting a first component of the environment upon detecting the deviation from the baseline of the non-nutritive sucking if the deviation is of a first type; and
adjusting a second component of the environment upon detecting the deviation from the baseline of the non-nutritive sucking if the deviation is of a second type of deviation; wherein the first component of the environment is different from the second component of the environment, and the first type of deviation is different from the second type of deviation.

26) The method of claim 25 wherein the first type of deviation is indicative of a level of agitation.

27) The method of claim 25 wherein the second type of deviation is indicative of a level of wakefulness.

28) A pacifier adapted to detect non-nutritive sucking events, the pacifier comprising:
a nipple;
a base attached to the nipple;
a sensor attached to the base, the sensor adapted to detect non-nutritive sucking events produced by an infant sucking on the nipple; and
an information device attached to the base and operatively connected to the sensor, the information device adapted to:
monitor the non-nutritive sucking of the infant;
determine a baseline of the non-nutritive sucking;
detect a deviation from the baseline of the non-nutritive sucking; and
adjust a first component of the environment upon detecting the deviation from the baseline of the non-nutritive sucking.
